(19) United States
(12) Patent Application Publication
(10) Pub. No.: US 2025/0356284 A1
(43) Pub. Date: Nov. 20, 2025

(54) IT OPERATION MANAGEMENT APPARATUS AND METHOD

(71) Applicant: Hitachi, Ltd., Tokyo (JP)

(72) Inventors: Masayuki KAKIDA, Tokyo (JP); Masaharu UKEDA, Tokyo (JP)

(21) Appl. No.: 19/077,487

(22) Filed: Mar. 12, 2025

(30) Foreign Application Priority Data
May 14, 2024 (JP) 2024-078509

(51) Int. Cl. G06Q 10/0631

(52) U.S. Cl. CPC G06Q 10/06313

(57) ABSTRACT

An environment-constructing apparatus selects a container to be a preemption target in accordance with characteristics of a workload of each of a plurality of containers in an operational environment. The environment-constructing apparatus includes a resource management unit, an operating information acquisition unit, and an environmental information storage unit. The resource management unit manages, as container deployment information, deployment of containers with respect to the operational environment. The operating information acquisition unit acquires, as container monitoring information, an operational status of resources operating in the operational environment. The environmental information storage unit stores the container deployment information and the container monitoring information. The resource management unit infers workload characteristics of running containers on the basis of the container deployment information and the container monitoring information and selects a container to be a preemption target from among the plurality of containers.

### CROSS-REFERENCE TO RELATED APPLICATION

The present application claims priority from Japanese application JP2024-078509, filed on May 14, 2024, the content of which is hereby incorporated by reference into this application.

### BACKGROUND

The present invention relates to an IT operation management apparatus and method.

In the field of Artificial Intelligence (AI) and, in particular, deep learning, high-performance Graphical Processing Units (GPUs) are required for large amounts of data processing and parallel computation. Given that GPUs are expensive, efficient resource allocation and job scheduling are important in an infrastructure shared by a plurality of development projects. On the other hand, while Central Processing Units (CPUs) are more commonly treated as cost-effective resources, proper use thereof is also important.

While Kubernetes is used for resource scheduling of workloads in common web services, Kubernetes does not fully address the needs of AI development. To fill this gap, an OSS called Kueue has been developed to address unique scheduling needs including AI development (Kueue, Internet <URL: https://kueue.sigs.k8s.io>).

Furthermore, WO 2022/079748 describes a method for determining GPU utilization based on code content in the aim of efficiently utilizing CPUs and GPUS.

### SUMMARY

When focusing on the problem of job scheduling in a GPU infrastructure, the job scheduling system according to Kueue, Internet <URL: https://kueue.sigs.k8s.io> allocates resources to a plurality of container programs on the basis of priority. During this process, low-priority container programs may be temporarily halted to secure the resources needed by high-priority container programs. Such an operation is called preemption. However, when a low-priority container program is stopped by preemption, the throughput of the program is reduced to zero.

Furthermore, in WO 2022/079748, the content of a source code of a program to be deployed is analyzed to determine GPU use. However, with this determination method, a type of infrastructure to be utilized cannot be identified when the content of a program cannot be analyzed. This makes it difficult to dynamically and efficiently select and allocate resource types.

The present invention has been made in consideration of the problems described above and an object thereof is to provide a technique for appropriately managing resources.

In order to achieve the object described above, the present invention is an IT operation management apparatus selecting a container to be a preemption target in accordance with workload characteristics of each of a plurality of containers in an operational environment, the IT operation management apparatus including: a resource management unit configured to manage, as container deployment information, a deployment of the containers in the operational environment; an operation information acquisition unit configured to acquire, as container monitoring information, an operation status of a resources operating in the operational environment; and an environment information storage unit configured to store the container deployment information and the container monitoring information, wherein the resource management unit is configured to infer the workload characteristics of running containers on the basis of the container deployment information and the container monitoring information and to select a container to be a preemption target from the plurality of containers.

According to the present invention, resources can be appropriately managed.

### BRIEF DESCRIPTION OF THE DRAWINGS

FIG. 1 is a functional block diagram showing a configuration example of an environment-constructing apparatus according to a first embodiment;

FIG. 2 is a diagram representing an example of a preemption target candidate table according to the first embodiment;

FIG. 3 is a diagram representing examples of container deployment instruction information and container deployment information according to the first embodiment;

FIG. 4 is a diagram representing examples of container monitoring information and node monitoring information according to the first embodiment;

FIG. 5 is a block diagram showing an example of an operational environment in which a hypervisor is not used according to the first embodiment;

FIG. 6 is a block diagram showing an example of an operational environment using a hypervisor according to the first embodiment;

FIG. 7 is a flow chart showing an example of container deployment processing according to the first embodiment;

FIG. 8 is a diagram representing examples of container deployment instruction information and container deployment information according to the first embodiment;

FIG. 9 is a flow chart showing an example of preemption target selection processing according to the first embodiment; and

FIG. 10 is a diagram representing an example of container deployment instruction information according to a second embodiment.

### DETAILED DESCRIPTION OF THE EMBODIMENT

In the present embodiment, a method and system for optimizing utilization of GPU (Graphical Processing Unit) resources and improving operational management of an IT system will be described. Specifically, the description will focus on a process of determining preemption with respect to GPU resources. Hereinafter, a configuration of a system for efficiently utilizing infrastructure, operating principles of the system, and classification and scheduling methods of programs based on the operating principles will be described.

For example, programs that use GPUs fall into two categories. One category contains programs that require the use of a GPU (hereinafter, referred to as “GPU-required”). The other category contains programs of which performance improves by using a GPU but are even capable of returning a practical response without using a GPU (hereinafter, referred to as “GPU-preferred”).

In order to secure the GPU resources required to deploy a new container program, a GPU-preferred container program is preferentially selected when selecting a target to be preempted from among existing container programs.

Furthermore, a preempted GPU-preferred container program is redeployed without utilizing a GPU. This will allow the program to continue to run at a certain level of performance even in situations where GPU resources are scarce.

It is assumed that the container program in operation in this case is designed to operate adaptively regardless of whether the container program is present or absent in the execution environment. The program is equipped with a function to use computing resources of a GPU if present or to perform processing by alternative means of computation such as a CPU if a GPU is not present.

Hereinafter, embodiments will be described with reference to the drawings. Note that the following embodiments are merely examples of implementation and are not intended to limit the invention itself to the specific contents described below.

Furthermore, the description of the following embodiments and the configuration and processing shown in each drawing are intended to provide an overview of the embodiments to the extent necessary for understanding and implementing the present invention and are not intended to limit the implementation of the present invention. In addition, each embodiment and each modification can be combined in part or in whole to the extent that they are consistent with each other without departing from the purport of the present invention.

### First Embodiment

In the present embodiment, a case where a deployment of a container program that uses a GPU is newly requested in a state without available GPU resources is assumed. The present embodiment shows processing of selecting a container program that does not pose a practical problem without using a GPU from among running container programs as a preemption target and subsequently redeploying the selected container program without using the GPU.

### Description of System

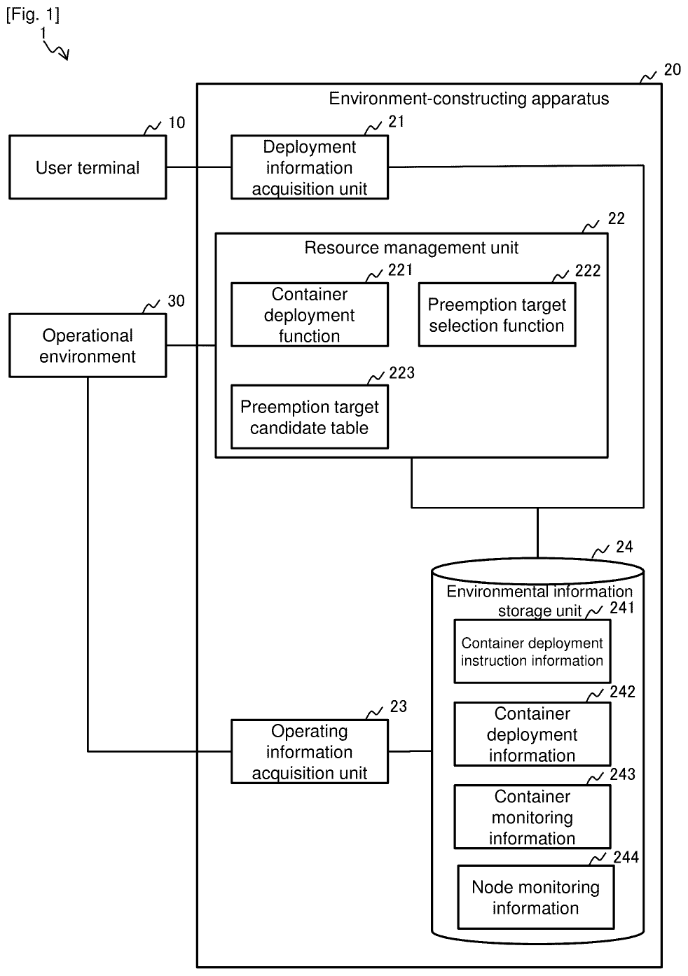

FIG. 1 is a diagram showing a functional configuration example of an environment-constructing apparatus according to a first embodiment.

An IT operation management system 1 includes a user terminal 10, an environment-constructing apparatus 20 as an example of an “IT operation management apparatus”, and an operational environment 30. The environment-constructing apparatus 20 shown in FIG. 1 can deploy container programs in the operational environment 30 when container deployment instruction information is communicated via the user terminal 10 by a user who wishes to deploy a container program in operation.

The environment-constructing apparatus 20 includes a deployment information acquisition unit 21, a resource management unit 22, an operating information acquisition unit 23, and an environmental information storage unit 24.

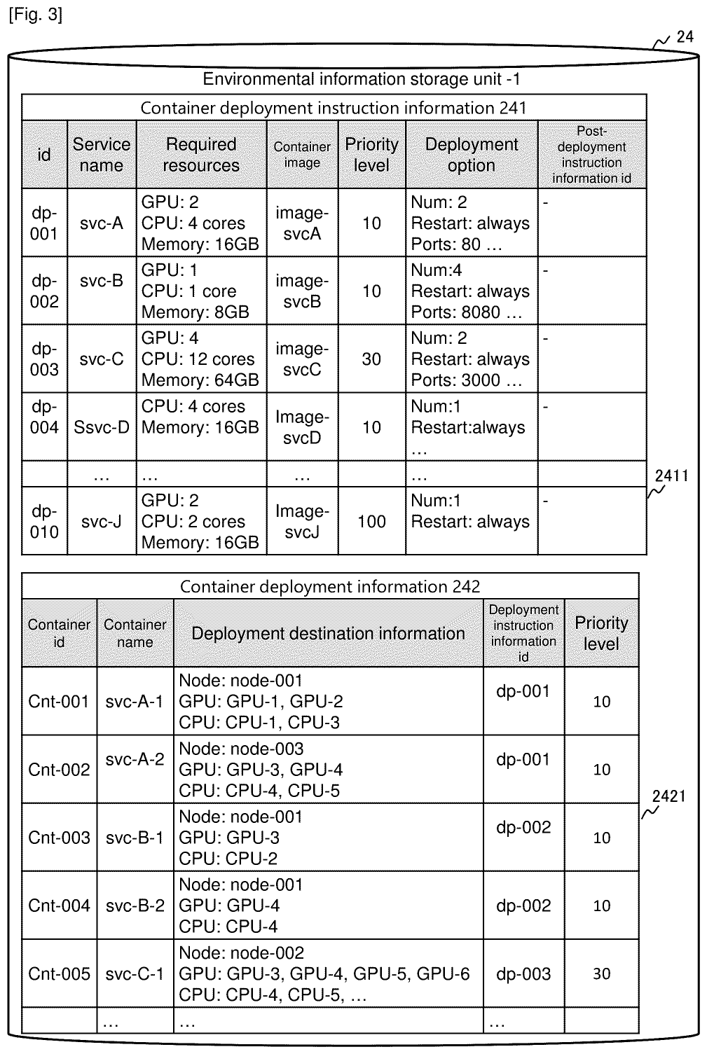

The deployment information acquisition unit 21 can store container deployment instruction information input from the user terminal 10 operated by a user in the environmental information storage unit 24. The container deployment instruction information will be described in detail later with reference to FIG. 3.

The resource management unit 22 includes a container deployment function 221, a preemption target selection function 222, and a preemption target candidate table 223.

The container deployment function 221 can allocate necessary resources from the operational environment 30 to a container program based on container deployment instruction information 241 stored in the environmental information storage unit 24 and execute the container program on the operational environment 30. The container deployment function 221 refers to known resource scheduling processing.

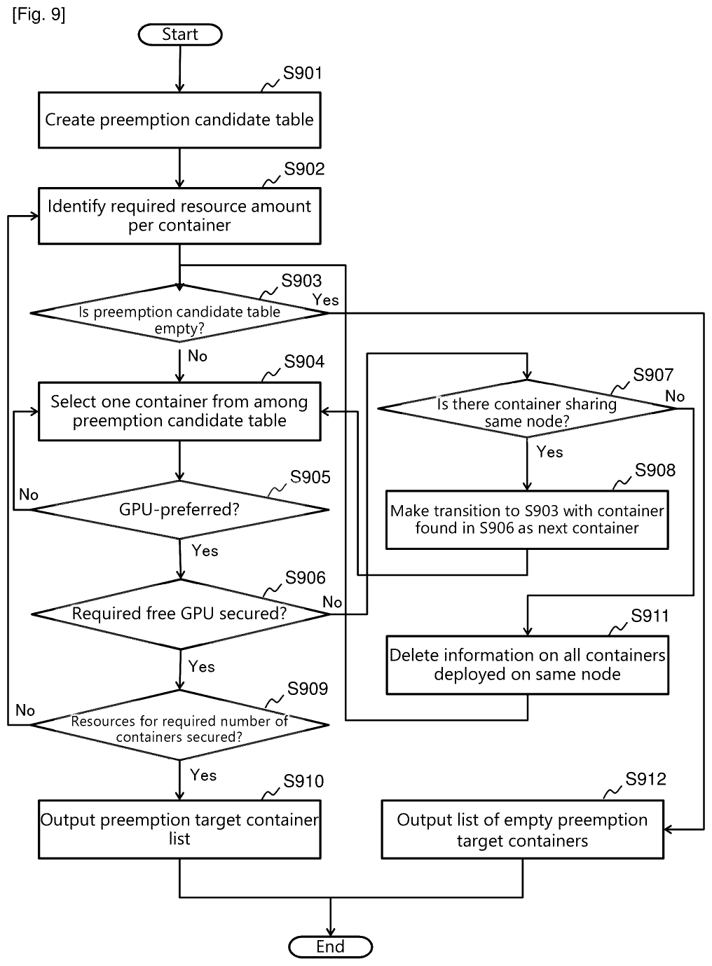

The preemption target selection function 222 executes characteristic preemption target selection processing. The preemption target selection processing uses not only a priority of a container but also characteristics of the container in terms of whether or not the container is capable of returning a practical response even if using a processor other than a GPU as an example of a “first processor” (whether or not the container is GPU-preferred) as criteria for selecting a target to be preempted. The preemption target selection processing will be described in detail later with reference to FIG. 9.

The preemption target candidate table 223 is data that is temporarily used in preemption target selection processing.

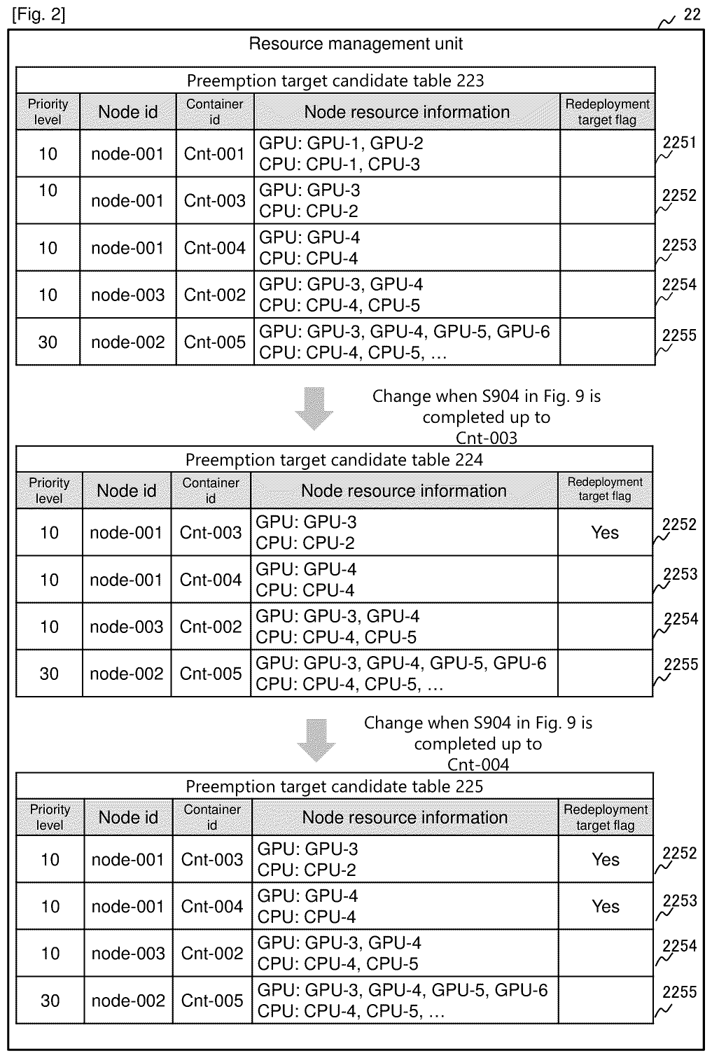

FIG. 2 is a diagram representing an example of the preemption target candidate table according to the first embodiment.

The preemption target candidate table 223 includes a priority level, a node id, a container id, node resource information, and a redeployment target flag.

The priority level is a value related to priority of execution. The node id is an identifier to uniquely identify a node where a container that is a preemption target candidate is deployed. The container id is an identifier to uniquely identify a container. The node resource information indicates resources on the node being utilized by each container. The redeployment target flag represents being redeployed without using a GPU after being preempted.

Let us now return to FIG. 1. The operating information acquisition unit 23 acquires an operational status of resources operating in the operational environment 30 as container monitoring information 243. Specifically, the operating information acquisition unit 23 periodically acquires container monitoring information 243 in the operational environment 30 and stores the compute nodes running the containers and resource information being used by the containers in the environmental information storage unit 24. The operating information acquisition unit 23 pays particular attention to the resource information being used by the containers and stores the resource information as container monitoring information 243.

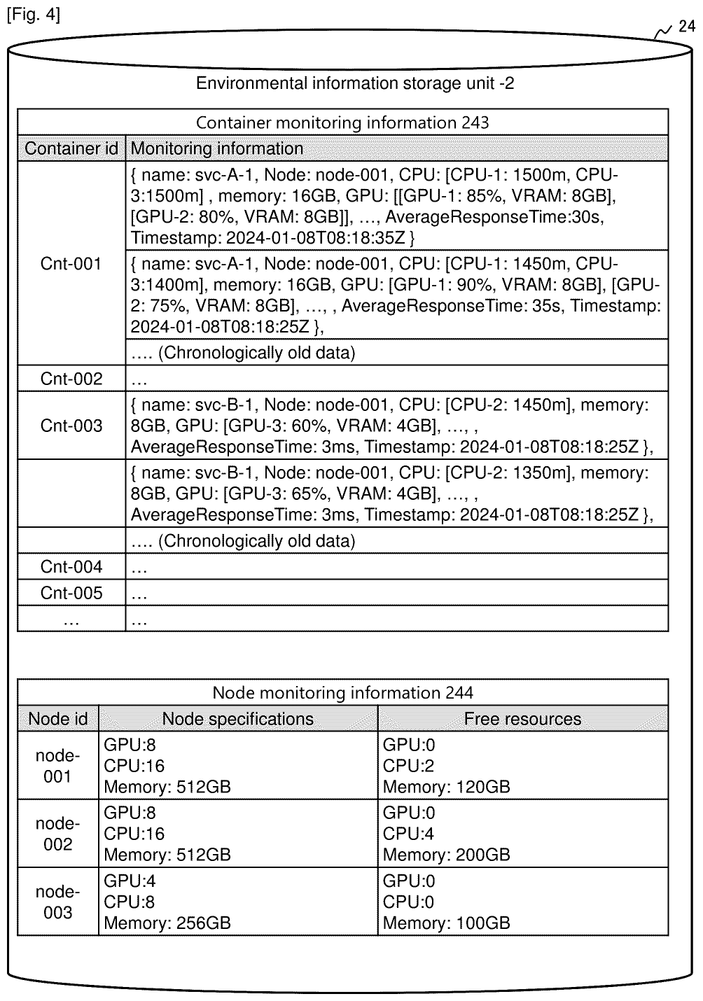

FIG. 3 is a diagram representing examples of container deployment instruction information and container deployment information, and FIG. 4 is a diagram representing examples of container monitoring information and node monitoring information according to the first embodiment.

As shown in FIGS. 3 and 4, the environmental information storage unit 24 includes container deployment instruction information 241, container deployment information 242, container monitoring information 243, and node monitoring information 244.

The container deployment instruction information 241 is data containing conditions such as the number of containers desired by the user to be executed and required resources having been transmitted to the deployment information acquisition unit 21 via the user terminal 10. The container deployment instruction information 241 includes an id, a service name, required resources, a container image, a priority level, a deployment option, and a post-deployment instruction information id.

The id is an identifier to uniquely identify the container deployment instruction information 241. The service name is an identifier that enables the user to uniquely identify processing contents to be executed by the container. The required resources represent amounts of a GPU, a CPU (Central Processing Unit) as an example of the “second processor”, a memory, and the like that are required to execute the container. The container image is an identifier to uniquely identify a container to be executed. The priority level is a value related to priority of execution. The deployment option represents the number of executions and whether or not a restart is required when an error occurs. The post-deployment instruction information id represents historical information in which a deployment instruction has been changed by preemption accompanied by a deployment. Note that the lower the priority, the lower the priority level, and the higher the priority, the higher the priority level.

The container deployment information 242 is data related to a container deployed in the operational environment 30. The container deployment information 242 includes a container id, a container name, deployment destination information, a deployment instruction information id, and a priority level.

The container id is an identifier to uniquely identify a container instance. The container name is an identifier that enables the user to uniquely identify processing contents of a container. The deployment destination information represents ids of a node where a container instance is deployed and resources utilized by the node. The deployment instruction information id indicates a basis for deployment. The priority level is a value related to priority of execution.

The container monitoring information 243 is data monitored by the operating information acquisition unit 23 for container programs deployed and executed in the operational environment 30. The container monitoring information 243 includes a container id and monitoring information.

The container id is an identifier to uniquely identify a container that is a monitoring target. Monitoring information is time-series data of a result of monitoring the container that is a monitoring target. Note that the monitoring information may include a node where the container is deployed, an amount of resources being used by the container, an average response time of requests being processed by the container, and timestamp information on a time point at which the monitoring information was obtained.

The node monitoring information 244 is data monitored by the operating information acquisition unit 23 for compute nodes that constitute the operational environment 30. The node monitoring information 244 includes a node id, node specifications, and free resources.

The node id is an identifier to uniquely identify a compute node. The node specifications represent an amount of resources possessed by the node. The free resources represent unused resources that have not yet been secured for container deployment in the compute node.

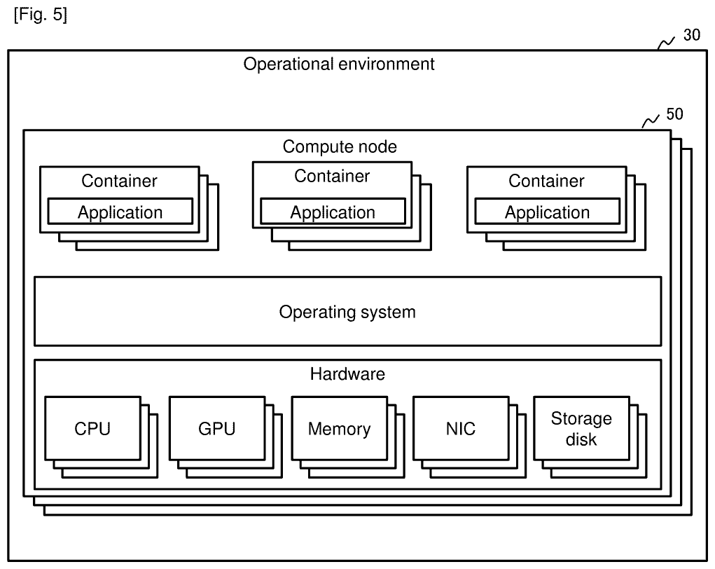

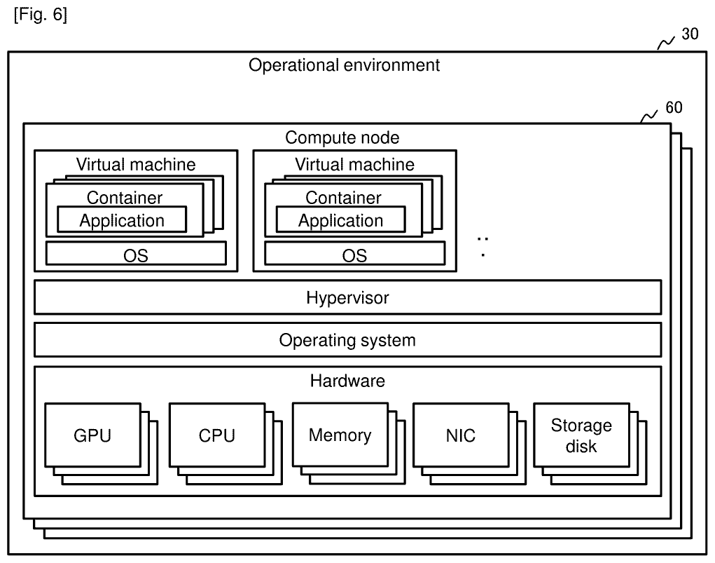

FIG. 5 is a block diagram showing an example of an operational environment in which a hypervisor is not used according to the first embodiment, and FIG. 6 is a block diagram showing an example of an operational environment using a hypervisor according to the first embodiment.

As shown in FIGS. 5 and 6, the operational environment 30 includes compute nodes 50 and 60 that use virtualization technology. One of these types of compute nodes 50 and 60 is used for the operational environment 30. In addition, one or a plurality of compute nodes are combined to form the operational environment 30 where containers are deployed and executed.

As shown in FIG. 5, each compute node 50 includes a large number of pieces of hardware. The hardware may include one or a plurality of each of a CPU, a GPU, a memory, a network interface card (NIC), and a storage disk (disk drive). The disk drive can include a solid state drive or a hard disk drive, or some combination of the two. The compute node 50 executes a host operating system on the hardware. One or more container programs are executed on the host operating system.

In a similar manner, as shown in FIG. 6, each compute node 60 includes a large number of pieces of hardware. The hardware may include one or a plurality of each of a GPU, a CPU, a memory, a network interface card (NIC), and a storage disk (disk drive). The disk drive can include a solid state drive or a hard disk drive, or some combination of the two. The compute node 60 executes a host operating system on the hardware. The compute node 60 also includes a hypervisor to share and manage hardware, thereby allowing a plurality of different virtual machines isolated from each other to run on the same compute node (physical machine) 60. Each compute node 60 may contain one or a plurality of virtual machines, each of which may include a guest operating system and one or a plurality of container programs that run on the guest operating system.

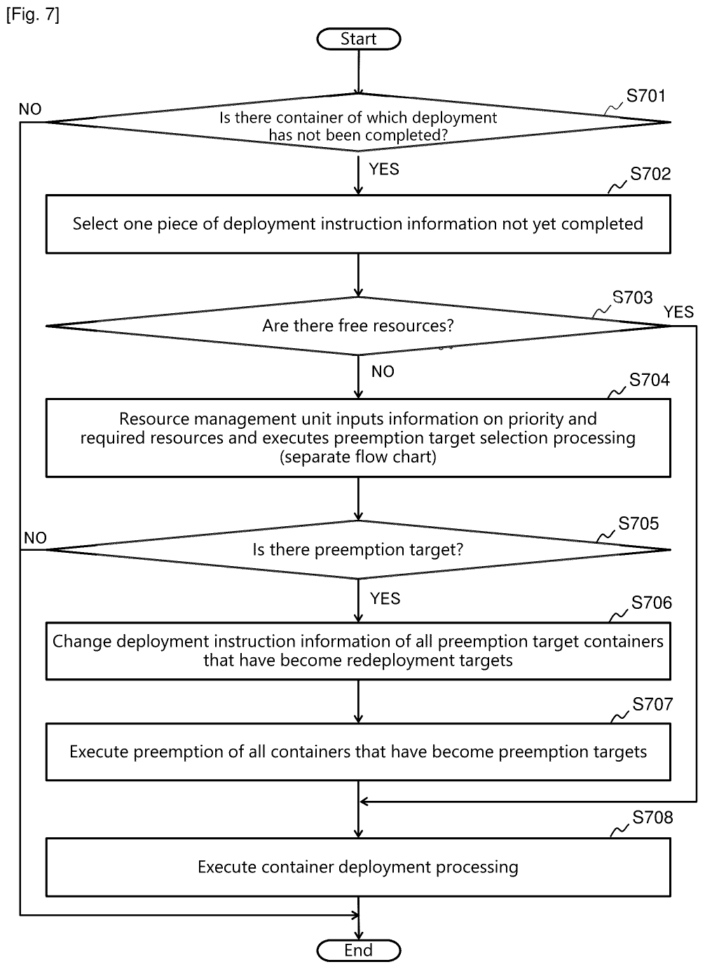

Next, a flow related to container deployment to the operational environment 30 in the resource management unit 22 according to the present embodiment will be described with reference to FIG. 7.

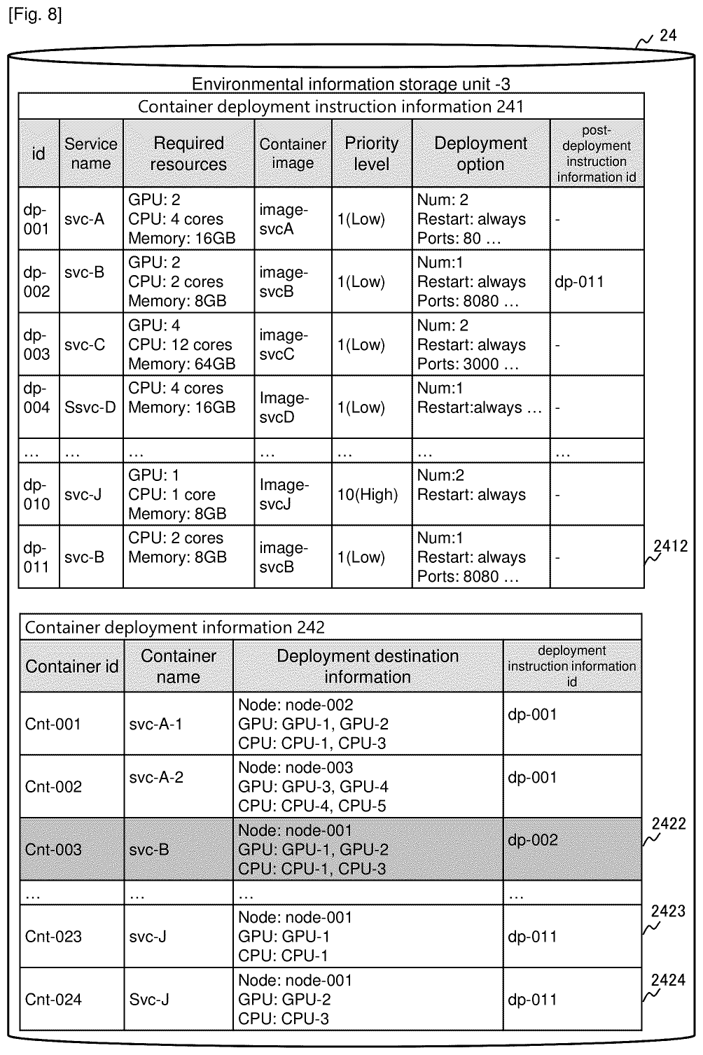

FIG. 7 is a flow chart showing an example of container deployment processing according to the first embodiment, and FIG. 8 is a diagram representing examples of container deployment instruction information and container deployment information according to the first embodiment.

The resource management unit 22 periodically starts the processing shown in FIG. 7. First, the resource management unit 22 refers to the container deployment instruction information 241 and the container deployment information 242 stored in the environmental information storage unit 24 and determines whether or not there is a container program of which deployment has not been completed (S701). When the determination result of S701 is false (S701: NO) or, in other words, when the deployment of all containers has been completed, the resource management unit 22 ends the processing as it is and awaits a timing of a next periodic execution. When the determination result of S701 is true (S701: YES) or, in other words, when there is one or a plurality of pieces of unexecuted deployment instruction information, the resource management unit 22 makes a transition to S702.

Next, in S702, the resource management unit 22 selects one of the pieces of unexecuted deployment instruction information and makes a transition to S703. In the example shown in FIG. 3, the resource management unit 22 selects container deployment instruction dp-010 of which deployment has not been completed in row 2411 of the container deployment instruction information 241 and makes a transition to S703.

Next, in S703, the resource management unit 22 refers to the container deployment information 242 and the node monitoring information 244 and determines whether or not there are free resources necessary for starting a new container or, in other words, whether there is a node capable of satisfying required resources. When the determination result of S703 is true (S703: YES) or, in other words, when there are free resources satisfying the requirement, the resource management unit 22 makes a transition to S708. When the determination result of S703 is false (S703: NO) or, in other words, when there is no free resource satisfying the requirement, the resource management unit 22 makes a transition to S704. In the example shown in FIG. 3, deployment instruction information dp-010 requests two containers' worth of resources of one GPU, two CPU cores, and 8 GB of memory per container. However, there is no free resource satisfying the request (node monitoring information 244 in FIG. 4). In this case, since a determination on whether or not to execute preemption must be made, a transition is made to S704.

Next, in S704, the resource management unit 22 executes the preemption target selection function 222 (preemption target selection processing). In the example shown in FIG. 3, required resource information of “one container's worth of two GPUs, two CPU cores, and 16 GB of memory for each container” and priority information of “priority 100” of deployment instruction information dp-010 are input to the resource management unit 22. As a result, the resource management unit 22 outputs containers Cnt-003 and Cnt-004 as preemption targets. A detailed description of the preemption target selection processing will be provided with reference to FIG. 9.

Next, in S705, the resource management unit 22 refers to the execution result of the preemption target selection function 222 and determines whether or not there is a preemption target. The determination result of S705 being false (S705: NO) means that there are no resources for newly creating a container and, at the same time, neither can free resources be created. In this case, processing shown in FIG. 7 is ended and the resource management unit 22 waits for a timing of a next periodic execution. When the determination result of S705 is true (S705: YES), the resource management unit 22 makes a transition to S706. In the example shown in FIG. 3, since the containers Cnt-003 and Cnt-004 are present as preemption targets, the resource management unit 22 makes a transition to S706.

Next, in S706, the resource management unit 22 changes deployment instruction information of containers that have become redeployment targets among the one or a plurality of preemption target containers. In the example shown in FIG. 3, there are two preemption target containers: the containers Cnt-003 and Cnt-004. By referring to row 2421 of the container deployment information 242 shown in FIG. 3, it is shown that the original placement instruction information for these containers is deployment instruction information dp-002.

GPU-related items are removed from the required resources in the deployment instruction information dp-002 to create new container deployment instruction information dp-011 (row 2412 of container deployment instruction information 241 in FIG. 8). Furthermore, the post-deployment instruction information id of the original deployment instruction information dp-002 is updated to dp-011. Accordingly, the deployment instruction information dp-002 is to be excluded from targets of a search for deployment incomplete containers in S701.

Next, in S707, the resource management unit 22 executes preemption of the containers that have become preemption targets. At this point, container Cnt-003 is stopped and deleted. At this time, the operating information acquisition unit 23 monitoring the operational environment 30 independently of the resource management unit 22 detects that containers Cnt-003 and Cnt-004 have been deleted and deletes row 2422 in the container deployment information 242 (FIG. 8).

Next, in S708, the container deployment function 221 of the resource management unit 22 executes container deployment processing based on the container deployment instruction information selected in S702. In the example shown in FIG. 3, based on deployment instruction information dp-010, the resource management unit 22 deploys containers Cnt-023 and Cnt-024 in the operational environment 30. At this time, the operating information acquisition unit 23 monitoring the operational environment 30 independently of the resource management unit 22 detects that two containers have been newly created and adds rows 2423 and 2424 in the container deployment information 242 (FIG. 8).

Next, a flow of preemption target selection processing by the preemption target selection function 222 of the resource management unit 22 will be described with reference to FIG. 9.

FIG. 9 is a flow chart showing an example of preemption target selection processing according to the first embodiment.

Preemption target selection processing is executed when deployment instruction information of a new container is found in order to search for a target to be stopped and deleted among containers already running for the purpose of securing resources. In S704 in FIG. 7, the preemption target selection function 222 receives, as input, required resource information and priority level information of a container program to be newly deployed. Subsequently, in S901, the preemption target selection function 222 creates the preemption target candidate table 223 while referring to the container deployment information 242, the container monitoring information 243, and the node monitoring information 244. In the example shown in FIG. 3, required resource information of “one container's worth of two GPUs, two CPU cores, and 16 GB of memory for each container” and priority information of “priority 100” of container deployment instruction dp-010 are input.

The preemption target selection function 222 extracts the container id and the deployment destination information of containers which use “GPU, CPU, and memory” and of which the priority level is lower than “10” and priority is low among the container information described in the container deployment information 242. Let us assume that, as a result, a table containing containers Cnt-001 to Cnt-005 is created. Data obtained by adding a column of redeployment target flags to the table is sorted in orders of priorities and deployment destination nodes to create a preemption target candidate table 223.

Next, in S902, the preemption target selection function 222 identifies an amount of requested resources per container from the requested resources and starts loop processing that repeats S904 and thereafter for the required number of containers. In the present embodiment, resources necessary for deploying a container with “two GPUs, two CPU cores, and 16 GB of memory” need only be secured once.

Next, in S903, the preemption target selection function 222 determines whether or not the contents of the preemption target candidate table 223 are empty. When the determination result of S903 is true (S903: YES), since resources cannot be secured by preemption, the preemption target selection function 222 makes a transition to S912. When the determination result of S903 is false (S903: NO), the preemption target selection function 222 makes a transition to S904. In the example shown in FIG. 3, since the preemption target candidate table 223 is not empty, a transition is made to S904.

Next, in S904, the preemption target selection function 222 selects one target from the preemption target candidate table 223 and starts processing of S905 and thereafter. The selection criterion at this time is basically to select one row at a time from the top of the table that does not have an entry of the redeployment target flag. In the example shown in FIG. 3, containers are executed in an order of Cnt-001, Cnt-003, Cnt-002, . . . .

Next, in S905, the preemption target selection function 221 refers to the container monitoring information 243 to determine whether the container selected in S904 uses a GPU but can return a practical response without using a GPU (GPU-preferred). When the determination result of S905 is true (S905: Yes), the preemption target selection function 222 enables the redeployment target flag and makes a transition to S906. When the determination result of S905 is false (S905: No), the preemption target selection function 222 deletes the selected row from the preemption target candidate table 223 and makes a transition to S904. In the example shown in FIG. 3, the container to be an initial target of execution of processing of S905 is container Cnt-001. Referring to container monitoring information 243, the time-series data from monitoring container Cnt-001 shows that AverageResponseTime, which indicates an average value of request processing times, is 30 seconds or longer and that a GPU utilization rate is also above 75%.

Generally, a difference in processing performance between a GPU and a CPU produces a difference in response performance of several to several thousand times. Therefore, if processing with a high GPU utilization rate but response time taking tens of seconds is processed only by a CPU without a GPU, a user transmitting a request to the container cannot be provided with practical response performance. Therefore, it can be determined that container Cnt-001 is not a GPU-preferred container. Therefore, the preemption target selection function 222 deletes row 2251 and makes a transition to S904 to perform a similar check on a next preemption candidate container. On the other hand, container Cnt-003 that is checked in S905 after container Cnt-001 has a GPU utilization rate of 65% or lower and AverageResponseTime of around 3 ms. Since such processing shows that processing times by a GPU is extremely short, it is highly likely that practical response times can be achieved even when processing is performed only with a CPU without using a GPU. Therefore, since a determination of a GPU-preferred container can be made, “Yes” is written to the redeployment target flag and a transition is made to S906. A state of the preemption target candidate table 223 at this time point is shown in a preemption target candidate table 224 in FIG. 2.

Next, in S906, the preemption target selection function 222 determines whether or not required free GPU can be secured if all valid containers are deleted. When the determination result of S906 is true (S906: Yes), the preemption target selection function 222 makes a transition to S909. When the determination result of S906 is false (S906: NO), the preemption target selection function 222 makes a transition to S907. In the example shown in FIG. 3, at this point, only Cnt-003 has the redeployment target flag enabled in the preemption target candidate table 224. Checking node resource information of Cnt-003, it is clear that if Cnt-003 were to be deleted, at least “one GPU and one CPU” would be released. Furthermore, checking the free resource information of node-002 read from the container monitoring information 243 and the node monitoring information 244, it is clear that even if container Cnt-003 is deleted, resources to meet the requirements of “two GPUs, two CPU cores and 16 GB of memory per container” cannot be secured with node-002. Therefore, the preemption target selection function 222 makes a transition to S907.

Next, in S907, the preemption target selection function 222 determines whether or not there is a container running on the same compute node as the container selected in S904 in the preemption target candidate table 223. When the determination result of S907 is true (S907: Yes), the preemption target selection function 222 makes a transition to S908. When the determination result of S907 is false (S907: NO), the preemption target selection function 222 makes a transition to S911. In the example shown in FIG. 3, Cnt-004 is listed in the preemption target candidate table 224 as a container which is deployed on the same node node-001 as container Cnt-003 and of which a relocation target flag is not yet entered at this time. Therefore, the preemption target selection function 222 makes a transition to S908.

In S908, the preemption target selection function 222 makes a transition to S904 with the container found in S907 as the next container and repeats processing of S905 and thereafter. In the example shown in FIG. 3, since container Cnt-004 is found in S907, the preemption target selection function 222 repeats processing of S905 and thereafter on Cnt-004 as a target. Since Cnt-004 is a container instance based on the same container deployment instruction information 241 as Cnt-003, in the example shown in FIG. 3, it is assumed that characteristics of processing similar to Cnt-003 has been read from the monitoring information 243. In this case, the result of S905 is “Yes” and the result of S906 is “can be secured”. A state of the preemption target candidate table 223 at the time point of completion of S906 is shown in a preemption target candidate table 225 in FIG. 2.

Next, in S909, the preemption target selection function 222 performs end determination of the loop processing started in S902. In other words, the preemption target selection function 222 determines whether or not resources have been secured to deploy the required number of containers. When the determination result of S909 is true (S909: Yes), the preemption target selection function 222 makes a transition to S910. When the determination result of S909 is false (S909: NO), the preemption target selection function 222 makes a transition to S902 and searches for a next resource for containers. In the example shown in FIG. 3, since “one container's worth of two GPUs, two CPU cores, and 16 GB of memory for each container” has been input as required resources, the requirement can be satisfied by preempting containers Cnt-003 and Cnt-004. Therefore, the preemption target selection function 222 makes a transition to S910.

Next, in S910, the preemption target selection function 222 outputs the rows in which the redeployment target flag is enabled as a preemption target container list that is a result of execution of the preemption target selection function 222. In the example shown in FIG. 3, rows 2252 and 2253 related to containers Cnt-003 and Cnt-004 of the preemption target candidate table 223 are output as the preemption target container list.

As described above, according to the present embodiment, the environment-constructing apparatus 20 selects containers to be preemption targets based on characteristics of a workload of each of a plurality of containers in the operational environment 30. The environment-constructing apparatus 20 includes the resource management unit 22, the operating information acquisition unit 23, and the environmental information storage unit 24. The resource management unit 22 manages deployment of containers with respect to the operational environment 30 as container deployment information 242. The operating information acquisition unit 23 acquires an operational status of resources operating in the operational environment 30 as container monitoring information 243. The environmental information storage unit 24 stores the container deployment information 242 and the container monitoring information 243. The resource management unit 22 infers the workload characteristics of running containers based on the container deployment information 242 and the container monitoring information 243 and selects a container to be a preemption target from among a plurality of containers.

Accordingly, the throughput of programs that are preemption targets can be prevented from reaching zero and resources can be properly managed. Furthermore, since preempted GPU-preferred programs are redeployed without utilizing a GPU, the programs continue to operate while maintaining constant performance. Accordingly, a decline in overall system throughput can be minimized.

Furthermore, contents of source codes need not be analyzed. Since whether or not a program is GPU-required or GPU-preferred is identified based on monitoring information about the environment in which the program is running, whether or not a GPU is to be utilized can be determined even if the contents of a source code of the program are not known.

Furthermore, excess CPU resources can be effectively utilized. By redeploying preempted GPU-preferred programs using CPU resources when GPU resources are in short supply, unused CPU resources can be used efficiently and resource efficiency of the entire system can be improved.

Furthermore, the container monitoring information 243 includes a request processing time and a GPU utilization rate for each of a plurality of containers and the resource management unit 22 selects containers to be preemption targets based on the request processing times and the GPU utilization rates. Accordingly, containers can maintain practical response performances without the use of GPUS.

### Second Embodiment

In the first embodiment, a flow of resources being generated for higher-priority containers by preemption of running containers Cnt-003 and Cnt-004 was described. Hereinafter, a flow in a case where requested resource information input to the preemption target selection processing is too large and resources cannot be secured just by preemption will be described.

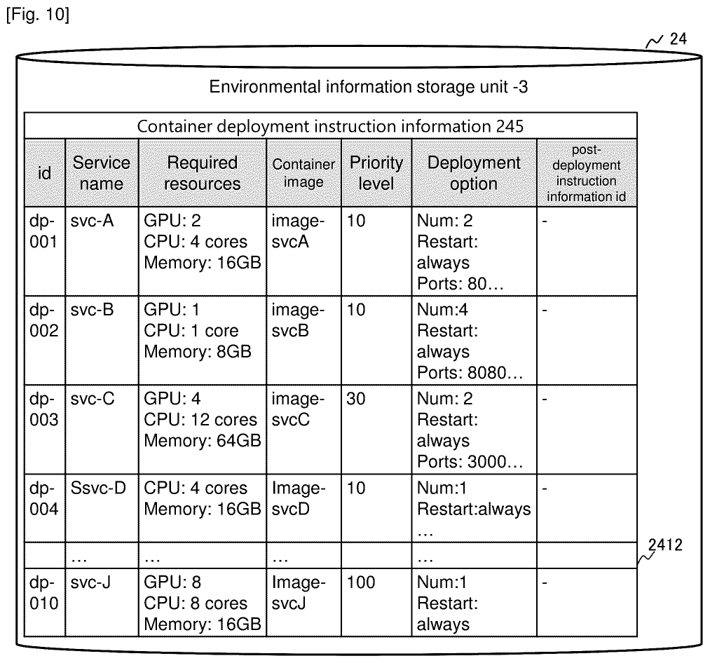

Let us consider a case where dp-010 included in the container deployment instruction information 241 requests “two containers' worth of eight GPUs, eight CPU cores, and 256 GB of memory per container” (row 2412 in FIG. 10). An overall flow is similar to the first embodiment. However, there is a difference in the preemption target selection processing in FIG. 9 at a time point where S906 is processed after the redeployment target flags corresponding to Cnt-003 and Cnt-004 are enabled (the preemption target candidate table 225 in FIG. 2). In the present embodiment, since the result of S906 is “cannot be secured”, the preemption target selection function 222 makes a transition to S907.

In S907, containers which are deployed on the node node-001 and of which a redeployment target flag is not yet entered are not present in the preemption target candidate table 223. Therefore, the preemption target selection function 222 makes a transition to S911.

Next, in S911, the preemption target selection function 222 deletes information on all containers deployed on a same compute node as Cnt-004 from the preemption target candidate table 223. In the example shown in FIG. 2, rows 2251, 2252, and 2253 of the preemption target candidate table 225 are deleted.

Next, in S903, the preemption target selection function 222 determines whether or not the preemption target candidate table 223 is empty. When the determination result of S903 is false (S903: NO), the preemption target selection function 222 makes a transition to S904. When the determination result of S903 is true (S903: Yes), the preemption target selection function 222 makes a transition to S912. In the example shown in FIG. 2, since rows 2254 and 2255 remain in the result of executing S911 and on the preemption target candidate table 225, the preemption target selection function 222 makes a transition to S904. Subsequently, processing of S905 and thereafter is implemented with respect to Cnt-002 and Cnt-005. However, since S906 will never produce a result of “Yes” regardless of the states of the two containers, S911 is executed in the processing of each container and a determination of “empty” is finally made in S903.

Next, in S912, the preemption target selection function 222 outputs a list of empty preemption target containers as a preemption target container list that is an execution result.

The present invention is not limited to the embodiments described above as they are and components may be modified and embodied without departing from the gist of the invention in the implementation stage or a plurality of components disclosed in the embodiments described above may be implemented in combination as appropriate.

For example, the container monitoring information 243 may include an amount of VRAM utilization for each of a plurality of containers and the resource management unit 22 may select containers to be preemption targets based on the amounts of VRAM utilization. Accordingly, containers can maintain practical response performances without the use of GPUs.

What is claimed is:

1. An IT operation management apparatus selecting a container to be a preemption target in accordance with characteristics of a workload of each of a plurality of containers in an operational environment, the IT operation management apparatus comprising:
a resource management unit configured to manage, as container deployment information, deployment of the containers with respect to the operational environment;
an operating information acquisition unit configured to acquire, as container monitoring information, an operational status of resources operating in the operational environment; and
an environmental information storage unit configured to store the container deployment information and the container monitoring information, wherein
the resource management unit is configured to infer workload characteristics of running containers on the basis of the container deployment information and the container monitoring information and to select a container to be a preemption target from among the plurality of containers.

2. The IT operation management apparatus according to claim 1, further comprising:
a deployment instruction information acquisition unit configured to acquire, as container deployment instruction information, a deployment instruction of the containers with respect to the operational environment, wherein
the resource management unit is configured to select a container to be the preemption target on the basis of the container deployment instruction information, the container deployment information, and the container monitoring information.

3. The IT operation management apparatus according to claim 1, wherein
the resources include a first processor and a second processor having a lower processing performance than the first processor, and
the resource management unit is configured to select, as the preemption target, a container to be redeployed from the first processor to the second processor.

4. The IT operation management apparatus according to claim 3, wherein
the first processor is a GPU, and
the second processor is a CPU.

5. The IT operation management apparatus according to claim 4, wherein
the container monitoring information includes a request processing time and a GPU utilization rate for each of the plurality of containers, and
the resource management unit is configured to select a container to be the preemption target on the basis of the request processing time and the GPU utilization rate.

6. The IT operation management apparatus according to claim 1, wherein
the container monitoring information includes a VRAM utilization amount of each of the plurality of containers, and
the resource management unit is configured to select a container to be the preemption target on the basis of the VRAM utilization amount.

7. An IT operation management method used by an IT operation management apparatus selecting a container to be a preemption target in accordance with characteristics of a workload of each of a plurality of containers in an operational environment, the IT operation management method comprising:
acquiring, as container deployment instruction information, a deployment instruction of the containers with respect to the operational environment;
acquiring, as container deployment information, a deployment of the containers with respect to the operational environment;
acquiring, as container monitoring information, an operational status of resources operating in the operational environment;
storing the container deployment instruction information, the container deployment information, and the container monitoring information; and
inferring workload characteristics of running containers on the basis of the container deployment information and the container monitoring information and selecting a container to be a preemption target from among the plurality of containers.

8. The IT operation management method according to claim 7, wherein
the selecting of the container to be the preemption target involves deploying the container to be the preemption target in the operational environment such that the container is processed by a CPU without using a GPU among the resources.

9. The IT operation management method according to claim 8, wherein
the container monitoring information includes a request processing time and a GPU utilization rate for each of the plurality of containers, and
the selecting of the container to be the preemption target involves selecting the container to be the preemption target on the basis of the request processing time and the GPU utilization rate.

10. The IT operation management method according to claim 7, wherein
the container monitoring information includes a VRAM utilization amount of each of the plurality of containers, and
the selecting of the container to be the preemption target involves selecting the container to be the preemption target on the basis of the VRAM utilization amount.
